(19) United States
(12) Patent Application Publication
(10) Pub. No.: US 2018/0128572 A1
(43) Pub. Date: May 10, 2018

(54) Gun Carrying Assembly

(71) Applicants: Kelly Carter, Rock Hill, SC (US); James Carter, Rock Hill, SC (US)

(72) Inventors: Kelly Carter, Rock Hill, SC (US); James Carter, Rock Hill, SC (US)

(21) Appl. No.: 15/348,231

(22) Filed: Nov. 10, 2016

(51) Int. Cl. F41C 33/06; B62B 9/26; A47B 81/00; E05G 1/00; G01S 19/42

(52) U.S. Cl. CPC F41C 33/06; B62B 9/26; A47B 81/005; B62B 2202/26; G01S 19/42; B62B 2202/41; E05G 1/005

(57) ABSTRACT

A gun carrying assembly includes a stroller that has a handle. A bag is provided and the bag is selectively suspended from the handle. A first tracking unit is coupled to the bag. The first tracking unit is in electrical communication with a gps satellite thereby facilitating the first tracking unit to establish a physical location of the bag. A safe is provided and a hand gun is positioned in the safe. The safe is releasably coupled to the bag such that the safe remains with the stroller when the bag is forcibly removed from the stroller. Thus, the hand gun is inhibited from being stolen. A second tracking unit is coupled to the safe. The second tracking unit is in electrical communication with the global positioning satellite to establish a physical location of the safe.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING ASSEMBLY

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to carrying devices and more particularly pertains to a new carrying device for facilitating a hand gun to be carried with a stroller.

### BRIEF SUMMARY OF THE INVENTION

An embodiment of the disclosure meets the needs presented above by generally comprising a stroller that has a handle. A bag is provided and the bag is selectively suspended from the handle. A first tracking unit is coupled to the bag. The first tracking unit is in electrical communication with a gps satellite thereby facilitating the first tracking unit to establish a physical location of the bag. A safe is provided and a hand gun is positioned in the safe. The safe is releasably coupled to the bag such that the safe remains with the stroller when the bag is forcibly removed from the stroller. Thus, the hand gun is inhibited from being stolen. A second tracking unit is coupled to the safe. The second tracking unit is in electrical communication with the global positioning satellite to establish a physical location of the safe.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded perspective view of a gun carrying assembly according to an embodiment of the disclosure.

FIG. 2 is a front phantom view of an embodiment of the disclosure.

FIG. 3 is a top view of an embodiment of the disclosure.

FIG. 4 is a perspective in-use view of an embodiment of the disclosure.

FIG. 5 is a perspective view of an alternative embodiment of the disclosure.

FIG. 6 is a schematic view of an embodiment of the disclosure.

### DETAILED DESCRIPTION OF THE INVENTION

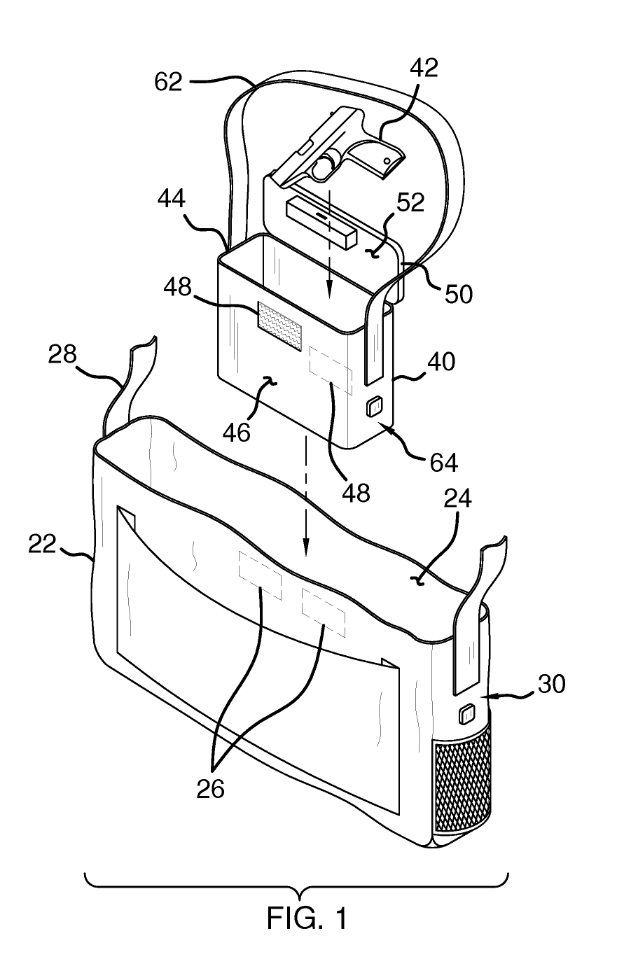

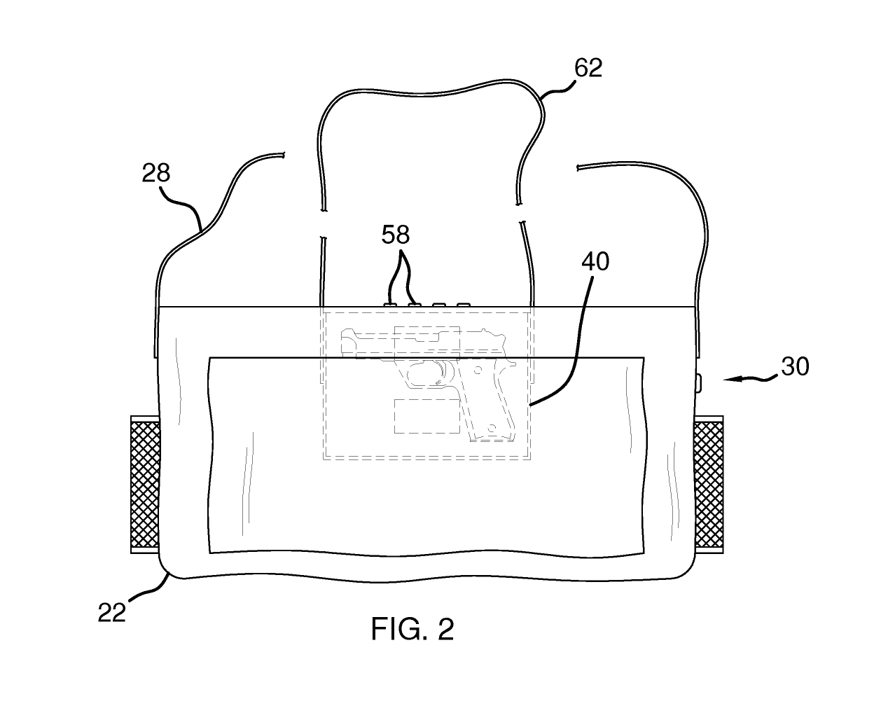

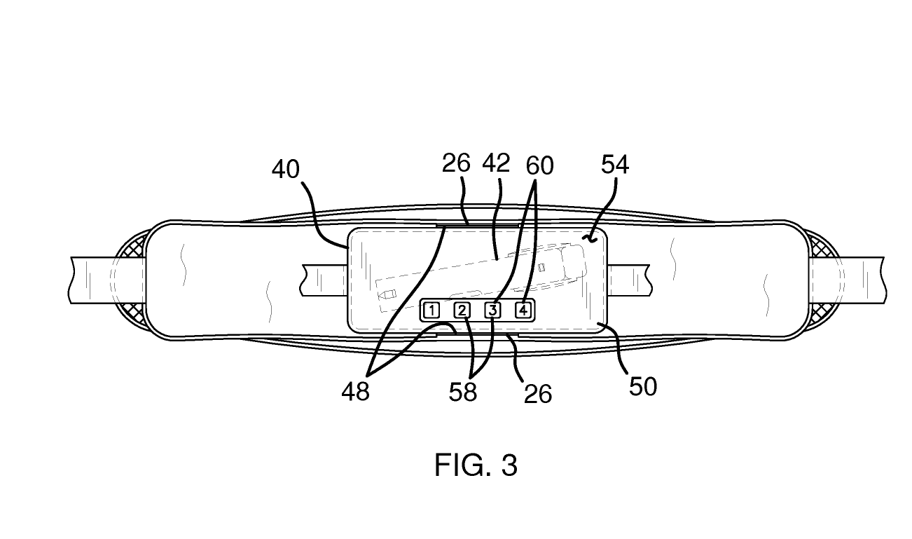

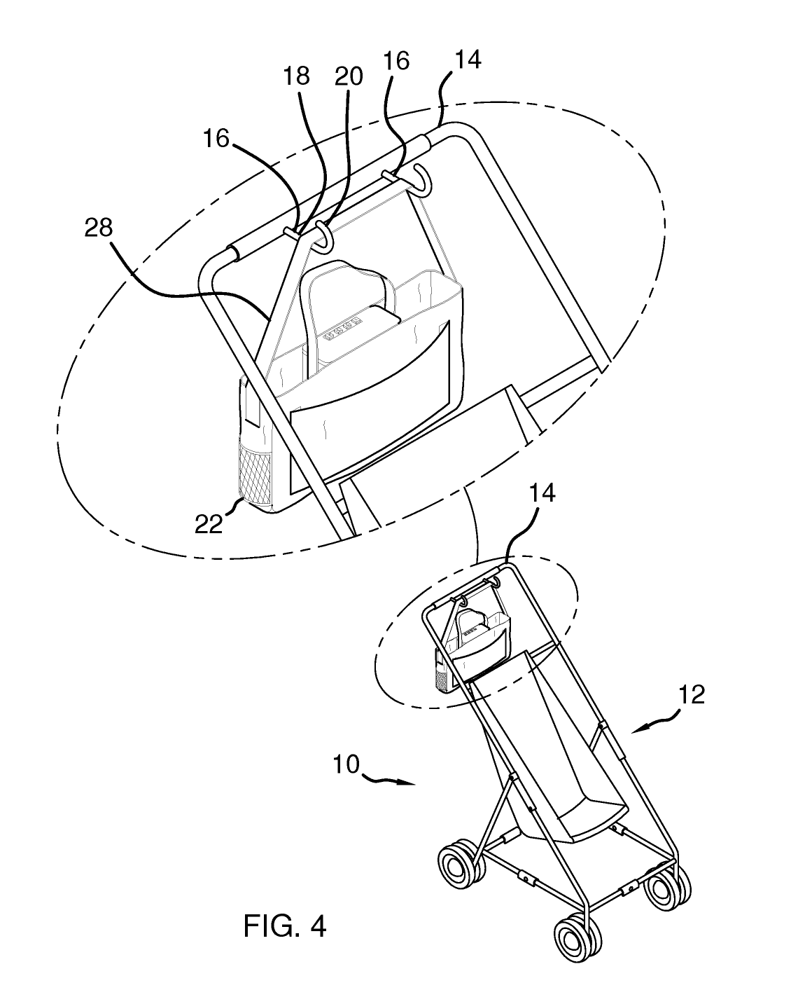

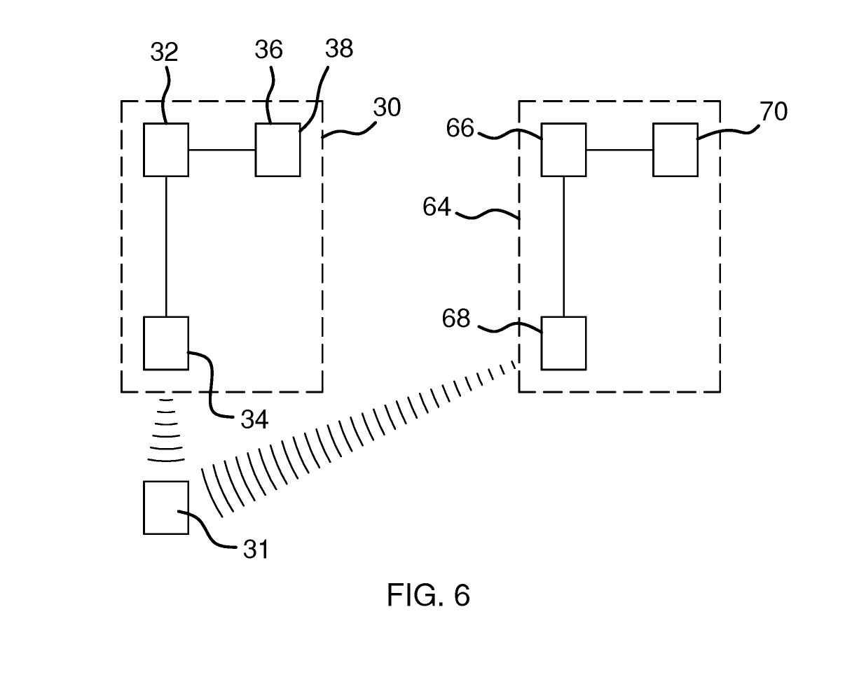

With reference now to the drawings, and in particular to FIGS. 1 through 6 thereof, a new carrying device embodying the principles and concepts of an embodiment of the disclosure and generally designated by the reference numeral 10 will be described.

As best illustrated in FIGS. 1 through 6, the gun carrying assembly 10 generally comprises a stroller 12 that may support a child. The stroller 12 has a handle 14 that is gripped thereby facilitating the stroller 12 to be urged along a support surface. The stroller 12 may be a wheeled stroller 12 of any conventional design employed to transport children.

A pair of hooks 16 is provided and each of the hooks 16 is coupled to the handle 14. The hooks 16 are spaced apart from each other. Each of the hooks 16 comprises a leg 18 and a foot 20. The leg 18 corresponding to each of the hooks 16 is coupled to the handle 14 having the foot 20 corresponding to each of the hooks 16 being directed upwardly.

A bag 22 is provided and the bag 22 may contain objects related to child care. The bag 22 is selectively suspended from the handle 14 to be accessible when the stroller 12 is pushed. The bag 22 has an inner surface 24 and the bag may be a diaper bag or the like. A plurality of first mating members 26 is provided and each of the first mating members 26 is coupled to the inner surface 24 of the bag 22. Each of the first mating members 26 may be a hook and loop fastener or the like. A first strap 28 is provided and the first strap 28 is coupled to the bag 22 such that the first strap 28 forms a closed loop. The first strap 28 is selectively hung on each of the hooks 16 such that the bag 22 is suspended from the hooks 16.

A first tracking unit 30 is provided and the first tracking unit 30 is coupled to the bag 22. The first tracking unit 30 is in electrical communication with a gps satellite 31 thereby facilitating the first tracking unit 30 to establish a physical location of the bag 22. The first tracking unit 30 comprises a first processor 32 that is coupled to the bag 22. The first processor 32 may be an electronic processor or the like.

A first global positioning satellite (gps) transceiver 34 is coupled to the bag 22. The first gps transceiver 34 is electrically coupled to the first processor 32 and the first gps transceiver 34 is in electrical communication with the gps satellite 31. The first gps transceiver 34 may be a radio frequency transceiver or the like.

A first power supply 36 is provided and the first power supply 36 is coupled to the bag 22. The first power supply 36 is electrically coupled to the first processor 32. Additionally, the first power supply 36 comprises at least one battery 38.

A safe 40 is provided and a hand gun 42 may be positioned in the safe 40. The safe 40 is selectively locked to inhibit the hand gun 42 from being removed from the safe 40 by an unauthorized user. The safe 40 is releasably coupled to the bag 22 to remain with the stroller 12 when the bag 22 is forcibly removed from the stroller 12. Thus, the safe 40 and the hand gun 42 are inhibited from being stolen. The safe 40 has a top side 44 and an outside surface 46 and the top side 44 is open to access an interior of the safe 40.

A plurality of second mating members 48 is provided and each of the second mating members 48 is coupled to the outside surface 46 of the safe 40. Each of the second mating members 48 releasably engages an associated one of the first mating members 26. Each of the second mating members 48 may be a hook and loop fastener or the like.

A lid 50 is hingedly coupled to the safe 40 and the lid 50 selectively covers the top side 44 when the lid 50 is closed. The lid 50 has a bottom surface 52 and a top surface 54. A lock 56 is coupled to the lid 50 and the lock 56 engages the safe 40 when the lid 50 is closed thereby retaining the lid 50 in a closed position. The lock 56 is positioned on the bottom surface 52 of the lid 50 and the lock 56 may be an electronic lock 56 or the like.

A plurality of buttons 58 is provided. Each of the buttons 58 is coupled to the lid 50 and each of the buttons 58 may be manipulated. Each of the buttons 58 is electrically coupled to the lock 56. The lock 56 disengages from the safe 40 when a pass key is entered with the buttons 58 and each of the buttons 58 is positioned on the top surface 54 of the lid 50. Each of the buttons 58 has indicia 60 printed thereon. The indicia 60 may be numbers and each of the buttons 58 may be sequentially manipulated to enter a pre-determined numerical code into the lock 56.

A second strap 62 is provided and the second strap 62 is coupled to safe 40. The second strap 62 forms a closed loop and the second strap 62 may be gripped. A second tracking unit 64 is provided and the second tracking unit 64 is coupled to the safe 40. The second tracking unit 64 in electrical communication with the global positioning satellite thereby facilitating the second tracking unit 64 to establish a physical location of the safe 40.

The second tracking unit 64 comprises a second processor 66 that is coupled to the safe 40. The second processor 66 may be an electronic processor or the like. A second global positioning satellite (gps) transceiver 68 is provided and the second gps transceiver 68 is coupled to the safe 40. The second gps transceiver 68 is electrically coupled to second processor 66 and the second gps transceiver 68 is in electrical communication with the gps satellite 31. The second gps transceiver 68 may be a radio frequency transceiver or the like. A second power supply 70 is provided and the second power supply 70 is electrically coupled to the second processor 66. The second power supply 70 comprises at least one battery 38.

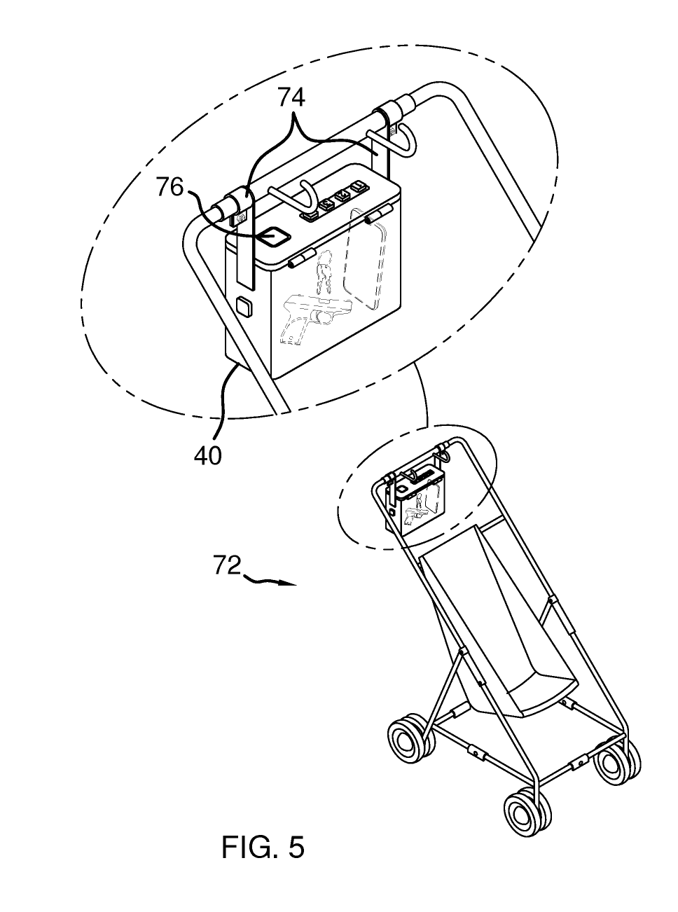

In an alternative embodiment 72 as shown in FIG. 5, a pair of fastening units 74 may each be coupled to the safe 40. Each of the fastening units 74 may be coupled to the handle 14 thereby facilitating the safe 40 to be suspended from the handle 14. Moreover, each of the fastening units 74 may be locking straps or the like. A fingerprint sensor 76 may be coupled to the top surface 54 of the lid 50 and the fingerprint sensor 76 may be electrically coupled to the lock 56. An authorized user may position a finger on the fingerprint sensor 76 to unlock the safe 40.

In use, the hand gun 42 is placed in the safe 40 and the lid 50 is positioned in the closed position. The safe 40 is positioned in the bag 22 and the first mating members 26 are mated to the second mating members 48. Thus, the safe 40 is releasably coupled to the bag 22. The safe 40 permits the hand gun 42 to be safely carried along with the contents of the bag 22. The first strap 28 on the bag 22 is suspended from the hooks 16 on the stroller 12. A user's arm may be extended through the second strap 62 on the safe 40. Thus, the safe 40 will break away from the bag 22 when the bag 22 is stolen or otherwise forcibly removed from the stroller 12 thereby inhibiting the hand gun 42 from being stolen. Each of the first tracking unit 30 and the second tracking unit 64 facilitates the bag 22 and the safe 40 to be located in the event of theft or loss.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A gun carrying assembly combining a gun safe and a stroller, said assembly comprising:
a stroller being configured to support a child, said stroller having a handle being configured to be gripped thereby facilitating said stroller to be urged along a support surface;
a bag being configured to contain objects related to child care, said bag being selectively suspended from said handle wherein said bag is configured to be accessible when said stroller is pushed;
a first tracking unit being coupled to said bag, said first tracking unit being configured to be in electrical communication with a gps satellite thereby facilitating said first tracking unit to establish a physical location of said bag;
a safe being configured to contain a hand gun, said safe being selectively locked wherein said safe is configured to inhibit the hand gun from being removed from said safe, said safe being releasably coupled to said bag wherein said safe is configured to remain with said stroller when said bag is forcibly removed from said stroller thereby inhibiting the hand gun from being stolen; and
a second tracking unit being coupled to said safe, said second tracking unit being configured to be in electrical communication with the global positioning satellite thereby facilitating said second tracking unit to establish a physical location of said safe.

2. The assembly according to claim 1, further comprising a pair of hooks, each of said hooks being coupled to said handle, said hooks being spaced apart from each other, each of said hooks comprising a leg and a foot, said leg corresponding to each of said hooks being coupled to said handle having said foot corresponding to each of said hooks being directed upwardly.

3. The assembly according to claim 1, further comprising:
said bag having an inner surface; and
a plurality of first mating members, each of said first mating members being coupled to said inner surface of said bag.

4. The assembly according to claim 2, further comprising a first strap being coupled to said bag such that said first strap forms a closed loop, said first strap being selectively hung on each of said hooks such that said bag is suspended from said hooks.

5. The assembly according to claim 1, wherein said first tracking unit comprises a first processor being coupled to said bag.

6. The assembly according to claim 5, further comprising a first global positioning satellite (gps) transceiver being coupled to said bag, said first gps transceiver being electrically coupled to said first processor, said first gps transceiver being configured to be in electrical communication with the gps satellite.

7. The assembly according to claim 5, further comprising a first power supply being coupled to said bag, said first power supply being electrically coupled to said first processor, said first power supply comprising at least one battery.

8. The assembly according to claim 3, further comprising:
said safe having an outside surface; and
a plurality of second mating members, each of said second mating members being coupled to said outside surface of said safe, each of said second mating members releasably engaging an associated one of said first mating members.

9. The assembly according to claim 1, further comprising:
said safe having a top side; said top side being open to access an interior of said safe; and
a lid being hingedly coupled to said safe, said lid selectively covering said top side when said lid is closed, said lid having a bottom surface and a top surface.

10. The assembly according to claim 9, further comprising a lock being coupled to said lid, said lock engaging said safe when said lid is closed thereby retaining said lid in a closed position, said lock being positioned on said bottom surface of said lid.

11. The assembly according to claim 10, further comprising a plurality of buttons, each of said buttons being coupled to said lid wherein each of said buttons is configured to be manipulated, each of said buttons being electrically coupled to said lock, said lock disengaging from said safe when a pass key is entered with said buttons, each of said buttons being positioned on said top surface of said lid.

12. The assembly according to claim 1, further comprising a second strap being coupled to safe such that said second strap forms a closed loop wherein said second strap is configured to be gripped.

13. The assembly according to claim 1, wherein said second tracking unit comprises a second processor being coupled to said safe.

14. The assembly according to claim 13, further comprising a second global positioning satellite (gps) transceiver, said second gps transceiver being electrically coupled to second processor, said second gps transceiver being configured to be in electrical communication with the gps satellite.

15. The assembly according to claim 13, further comprising a second power supply, said second power supply being electrically coupled to said second processor, said second power supply comprising at least one battery.

16. A gun carrying assembly combining a gun safe and a stroller, said assembly comprising:
a stroller being configured to support a child, said stroller having a handle being configured to be gripped thereby facilitating said stroller to be urged along a support surface;
a pair of hooks, each of said hooks being coupled to said handle, said hooks being spaced apart from each other, each of said hooks comprising a leg and a foot, said leg corresponding to each of said hooks being coupled to said handle having said foot corresponding to each of said hooks being directed upwardly;
a bag being configured to contain objects related to child care, said bag being selectively suspended from said handle wherein said bag is configured to be accessible when said stroller is pushed, said bag having an inner surface;
a plurality of first mating members, each of said first mating members being coupled to said inner surface of said bag;
a first strap being coupled to said bag such that said first strap forms a closed loop, said first strap being selectively hung on each of said hooks such that said bag is suspended from said hooks;
a first tracking unit being coupled to said bag, said first tracking unit being configured to be in electrical communication with a gps satellite thereby facilitating said first tracking unit to establish a physical location of said bag, said first tracking unit comprising:
a first processor being coupled to said bag,
a first global positioning satellite (gps) transceiver being coupled to said bag, said first gps transceiver being electrically coupled to said first processor, said first gps transceiver being configured to be in electrical communication with the gps satellite, and
a first power supply being coupled to said bag, said first power supply being electrically coupled to said first processor, said first power supply comprising at least one battery; and
a safe being configured to contain a hand gun, said safe being selectively locked wherein said safe is configured to inhibit the hand gun from being removed from said safe, said safe being releasably coupled to said bag wherein said safe is configured to remain with said stroller when said bag is forcibly removed from said stroller thereby inhibiting the hand gun from being stolen, said safe having a top side and an outside surface, said top side being open to access an interior of said safe;
a plurality of second mating members, each of said second mating members being coupled to said outside surface of said safe, each of said second mating members releasably engaging an associated one of said first mating members;
a lid being hingedly coupled to said safe, said lid selectively covering said top side when said lid is closed, said lid having a bottom surface and a top surface;
a lock being coupled to said lid, said lock engaging said safe when said lid is closed thereby retaining said lid in a closed position, said lock being positioned on said bottom surface of said lid;
a plurality of buttons, each of said buttons being coupled to said lid wherein each of said buttons is configured to be manipulated, each of said buttons being electrically coupled to said lock, said lock disengaging from said safe when a pass key is entered with said buttons, each of said buttons being positioned on said top surface of said lid;
a second strap being coupled to safe such that said second strap forms a closed loop wherein said second strap is configured to be gripped; and
a second tracking unit being coupled to said safe, said second tracking unit being configured to be in electrical communication with the global positioning satellite thereby facilitating said second tracking unit to establish a physical location of said safe, said second tracking unit comprising:
a second processor being coupled to said safe,
a second global positioning satellite (gps) transceiver, said second gps transceiver being electrically coupled to second processor, said second gps transceiver being configured to be in electrical communication with the gps satellite, and
a second power supply, said second power supply being electrically coupled to said second processor, said second power supply comprising at least one battery.
